(19) United States
(12) Patent Application Publication
(10) Pub. No.: US 2014/0078958 A1
(43) Pub. Date: Mar. 20, 2014

(54) SCHEMES FOR DETECTING WIRELESS NETWORKS

(71) Applicant: CAMBRIDGE SILICON RADIO LIMITED, Cambridge (GB)

(72) Inventors: Andrei Barbu Popescu, Cambridge (GB); Martin Robert Evans, Suffolk (GB); Paul Christopher McFarthing, Cambridge (GB)

(73) Assignee: Cambridge Silicon Radio Limited, Cambridge (GB)

(21) Appl. No.: 13/623,439

(22) Filed: Sep. 20, 2012

(51) Int. Cl. H04W 72/00

(52) U.S. Cl. 370/328

(57) ABSTRACT

A station for accessing the resources of an access point in a wireless network, the station including a transmitter that is arranged to formulate probe requests and a transmit chain that is arranged to transmit probe requests on multiple channels of the access point simultaneously, wherein the probe requests are configured to elicit responses from the access point. Also disclosed is a station for accessing the resources of an access point in a wireless network, wherein the network includes a plurality of channels at different frequencies and the station includes a receiver and a receive chain arranged to deliver to the receiver a signal that has been acquired wirelessly from the network and which spans a plurality of the channels, wherein the receiver is arranged to produce a first spectrogram of the signal and to make a determination, by comparing the first spectrogram with one or more earlier spectrograms of the signal, of whether there is communication starting in the network in a channel covered by the signal.

### FIELD

This application relates to wireless communications networks.

### BACKGROUND

It is known to organise wireless local area networks in accordance with the IEEE 802.11 standards. In such a network, an access point provides stations with access to a resource. Typically, the access point is a wireless router that provides access to a wired connection to the internet and the stations are WiFi enabled laptops or smart phones or the like. According to the IEEE 802.11 standards, an access point will transmit beacon frames and probe response frames that can be used by stations that want to access the resource (e.g. a broadband connection to the internet) that the access point controls.

A station that wants to join a wireless local area network can perform scans in order to find wireless local area networks to associate with. These scans can be “passive scans” or “active scans”.

In an active scan, a station will transmit a probe request frame on a selected frequency channel and will inspect the contents of any probe response frames that are received on that channel as a result. A probe request frame contains a service set ID (SSID) which may be a wild card SSID or a specific SSID (e.g. “BT Openzone”).

In a passive scan, a station will listen for wireless local area network traffic, including beacon frames and unsolicited probe response frames and will inspect the contents of the received frames in order to determine if it is in range of a network that it should associate with.

In portable devices, such as smart phones and tablet computers, scanning for wireless local area networks whilst roaming can consume a lot of energy. Often, portable or mobile devices spend a lot of time in transit, where no already-known networks are in range. Hence, it is beneficial to reduce the current that such devices consume in this scanning mode.

### SUMMARY

According to one aspect, certain embodiments of the invention provide a station for accessing the resources of an access point in a wireless network, the station comprising a transmitter that is arranged to formulate probe requests and a transmit chain that is arranged to transmit probe requests on multiple channels of the access point simultaneously, wherein the probe requests are configured to elicit responses from the access point.

The transmit chain may include a plurality of upconverters that all operate on a probe request from the transmitter, with each upconverter raising the frequency of the probe request to a respective frequency channel of the network.

Typically, the network has a plurality of channels which together form an operating band and each of the plurality of channels may have a respective upconverter in the plurality of upconverters.

According to another aspect, certain embodiments of the invention provide a station for accessing the resources of an access point in a wireless network, wherein the network comprises a plurality of channels at different frequencies and the station comprises a receiver and a receive chain arranged to deliver to the receiver a signal that has been acquired wirelessly from the network and which spans a plurality of the channels, wherein the receiver is arranged to produce a first spectrogram of the signal and to make a determination, by comparing the first spectrogram with one or more earlier spectrograms of the signal, of whether there is communication starting in the network in a channel covered by the signal.

### BRIEF DESCRIPTION OF THE DRAWINGS

By way of example only, various embodiments of the invention will now be described with reference to the accompanying drawings, in which:

FIG. 1 is a schematic block diagram of a station in a wireless local area network;

FIG. 2 is a diagram illustrating communication activity in a wireless local area network;

FIG. 3 is a schematic block diagram of an upconverter;

FIG. 4 is a schematic block diagram of a down converter;

FIG. 5 is a schematic block diagram of a transmitter;

FIG. 6 is a schematic block diagram of a receiver;

FIG. 7 is a schematic block diagram of a variant of the station shown in FIG. 1; and

FIG. 8 is a schematic block diagram of a transceiver.

### DETAILED DESCRIPTION

The drawings show various devices, but only in such detail as is sufficient to permit an efficient description of the invention. That is to say, it will be apparent to the skilled person that, in practice, the devices shown in the drawings will contain many more elements than are shown in the drawings or, indeed, than are described in the following text. It should also be borne in mind that elements carried over from one figure to another retain the same reference numerals.

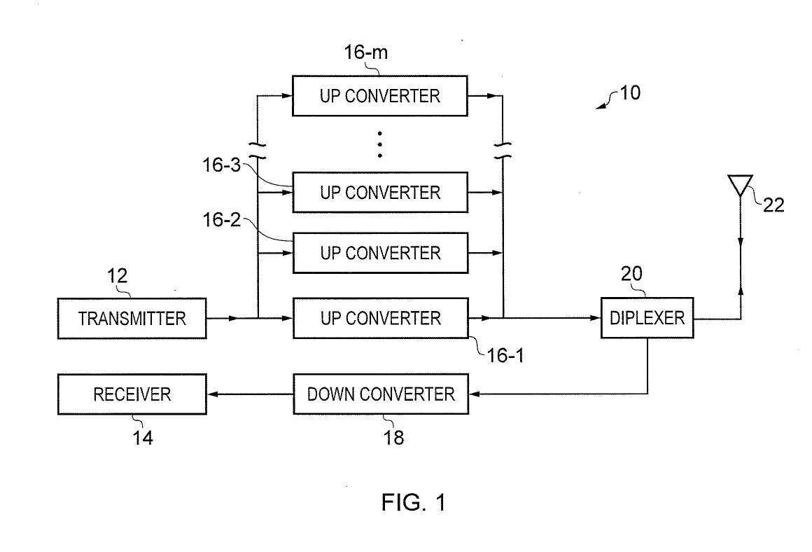

FIG. 1 shows a station 10 that can join an 802.11 wireless local area network that is established by an access point (not shown). The station 10 includes a transmitter 12, a receiver 14, a diplexer 20, and an antenna 22. In the transmit chain leading from the transmitter 12 to the antenna 22, there is a bank of parallel up converters 16-1 to 16m. In the receive chain leading from the antenna 22 to the receiver 14 is a downconverter 18.

The station 10 is designed to probe multiple channels of an 802.11 band simultaneously in order to search for networks that the station 10 can associate with. In order to achieve this, the transmitter 12 formulates a probe request frame and supplies it to the upconverters 16-1 to 16-m. Each of the upconverters 16-1 to 16-m upconverts the probe request frame in frequency to occupy a different channel of the 802.11 band that is being probed. The differently upconverted versions of the probe request frame that are produced by the upconverters 16-1 to 16-m and which now occupy distinct channels of the 802.11 band in question are merged and are fed to an antenna 22 (via a diplexer 20) for wireless transmission. Thus, the station 10 transmits probe request frames into m 802.11 channels simultaneously.

Signals that are received at the antenna 22 are routed by the diplexer 20 to a down converter 18. The down converter 18 converts received signals down in frequency to baseband, or to an intermediate frequency, so that they can be processed by the receiver 14. The down converter 18 admits to the receiver 14 only a span of the range of frequencies in the signal received by the down converter 18 from the antenna 22.

The receiver 14 can be operated in a channel reception mode or in a band reception mode. In the channel reception mode, the down converter 18 admits to the receiver 14 just that part of the signal from the antenna 22 that relates to a channel of interest within the 802.11 band that is in use. In the band reception mode, the down converter 18 admits to the receiver 14 the whole of the 802.11 band in question. The channel reception mode is used by the station 10 for receiving a dedicated communication in the selected channel or for studying, e.g. by way of passive scan, the communications, if any, are being conducted on that channel. The band reception mode is used by the station 10 to perform a Full Band Scan of all channels in the band, in a manner that will now be described.

In order to perform the Full Band Scan, the down converter 18 is placed in the band reception mode and the receiver 14 is arranged to calculate by a known discrete Fourier transform (DFT) technique a spectrogram for the signal that the receiver then receives from the down converter 18. The spectrogram is a list, plot or array of power values (typically in dB) for a series of frequency bins (each frequency bin is a relatively small frequency range).

The receiver 14 calculates the discrete Fourier transform of discrete blocks of the signal that is received from the down converter 18, these blocks extending over a predetermined time interval. These blocks are weighted by a window function before being applied to the discrete Fourier transform in order to reduce interference between non-adjacent frequency bins. Weighting signal blocks in this way is well known in the field of digital signal processing. A spectrogram can be considered as being composed of a series of values s(f,n), where f is an index specifying the frequency bin and n is an index specifying the time instant (i.e., n is an index denoting the block of the signal from the down converter 18 on which the spectrogram value was established).

The receiver 14 processes the spectrogram values in order to determine whether there are any probe response frames present in the signal that is provided by the down converter 18. To do this, the receiver 14 processes the spectrogram values according to the following equation:

$$b ( f , n ) = \{ \begin{matrix}1 , & if s ( f , n ) > s ( f , n - K ) \\ 0 , & otherwise\end{matrix}$$

The binary values b(f,n) that are thus produced are dependent on the historical values of the frequency bins of the spectrogram. The value K is an integer, and is not necessarily 1. These binary values can then be used to collate a detection criterion d_{c}(n) for each channel:

$${d}_{c} ( n ) = {\sum }_{f ∈ {F}_{c}} {\sum }_{k = n - L + 1}^{n} b ( f , k )$$

Where F_{c} is the set of frequency bins attributed to the channel c that is being tested and L is the number of decisions in time that are summed to produce d_{c}(n). A good choice of L is L=K. It will be understood that the equation for a detection criterion d_{c}(n) is in fact a two dimensional filter that filters over a range F_{c} of frequency and over a period L of time.

Having determined the detection criteria value for a given channel, the transmitter 14 compares this with a predetermined threshold. If the d_{c}(n) value for a given channel c exceeds the corresponding threshold then the receiver 14 assumes that a transmission has been received in that channel. The thresholds that are used with the d_{c}(n) values are determined on an experimental basis having regard to the precise nature of the system and operating environment in which they are to be used.

Once the receiver 14 determines that a transmission has been received in one of the monitored channels, the receiver 14 can then, operating in the channel reception mode, undertake a detailed scan of that channel, either a passive scan or an active scan, in order to determine if there is indeed a network on that channel with which the station 10 can associate.

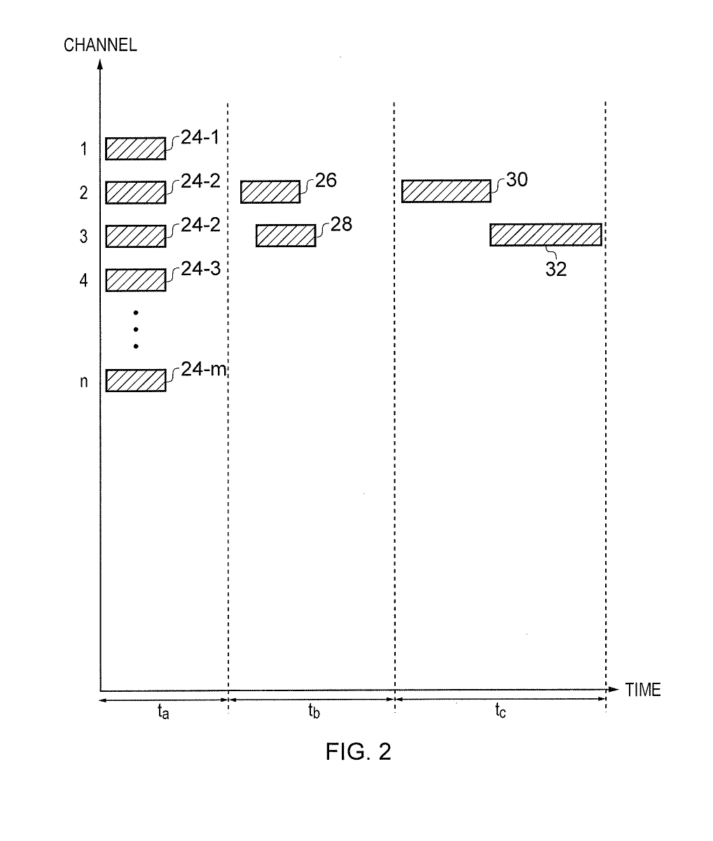

FIG. 2 outlines the stages in a process that is used by the station 10 to search for networks with which it can associate. In FIG. 2, the m channels are arranged vertically and activity in the channels is shown as shaded blocks. In time interval tₐ, the transmitter 10 sends a frequency multiplexed probe frame. That is to say, the transmitter 12 transmits via upconverters 16-1 to 16-m, probe requests in the m channels simultaneously. The probe requests appear as blocks 24-1 to 24-m. Then, in time interval t_{b}, the receiver 14 performs a Full Band Scan in order to analyse the signal that it receives from down converter 18 in an attempt to detect any transmissions that are being received on the m channels. If no transmissions are detected, i.e., if none of the d_{c}(n) exceed the threshold, then the station 10 can power down, by switching off at least some of its parts, for an interval since it can be assumed that there is presently no 802.11 access point for the station 10 to interact with. The duration of the power down interval can usefully be set so that the station 10 powers up once in every 802.11 frame to scan for access points.

In this example however, transmissions are received on channels 2 and 3, as indicated by shaded blocks 26 and 28. It will be observed that, in this example, the transmission on channel 2 is received slightly before the transmission that is received on channel 3. Assuming that the detection criterion values d_{c}(n) for channels 2 and 3 exceed the threshold, the station 10 performs, in interval t_{c}, sequential active scans of channels 2 and 3, as indicated by shaded blocks 30 and 32. Of course, one or both of the detected channels 2 and 3 could be subjected to a passive scan rather than an active scan.

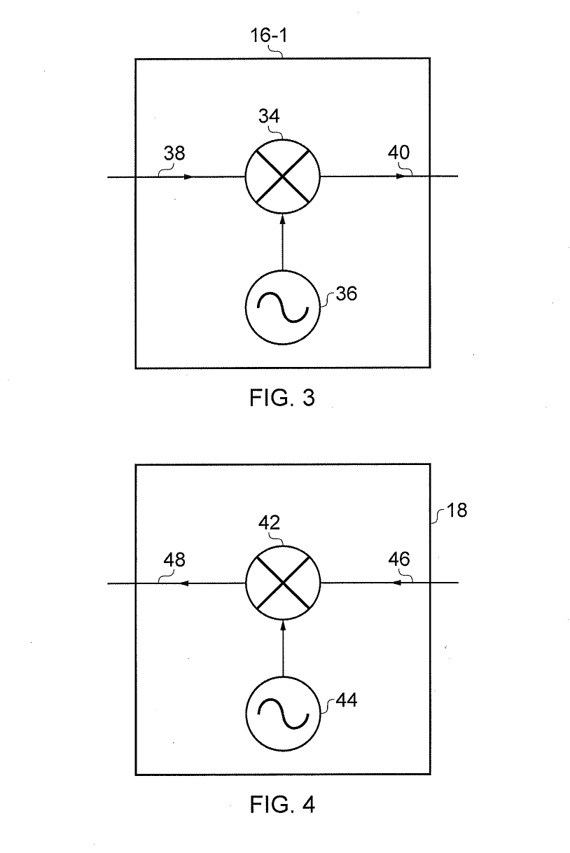

FIG. 3 shows upconverter 16-1 in more detail. It will be understood that the other upconverters 16-2 to 16-m have a similar construction. In essence, the upconverter 16-1 includes a mixer 34 and a local oscillator 36. The local oscillator 36 produces a radio frequency carrier signal onto which the signal 38 from the transmitter is modulated by the mixer 34. The resulting upconverted signal 40 is then combined with the outputs of the other upconverters 16-2 to 16-m, and supplied to the diplexer 20.

FIG. 4 shows the construction of the down converter 18. The down converter 18 comprises a mixer 42 and a local oscillator 44. The local oscillator 44 produces a radio frequency signal which the mixer 42 mixes with the signal 46 that is received from the diplexer 20 in order to produce the down converted, baseband signal 48 that is supplied to the receiver 14. The range of frequencies that the down converter 18 admits to the receiver 14 is controlled by a filter (not shown) that acts on signal 48. It is the pass band of that filter that is adjusted to change the down converter 18 between the band reception and channel reception modes.

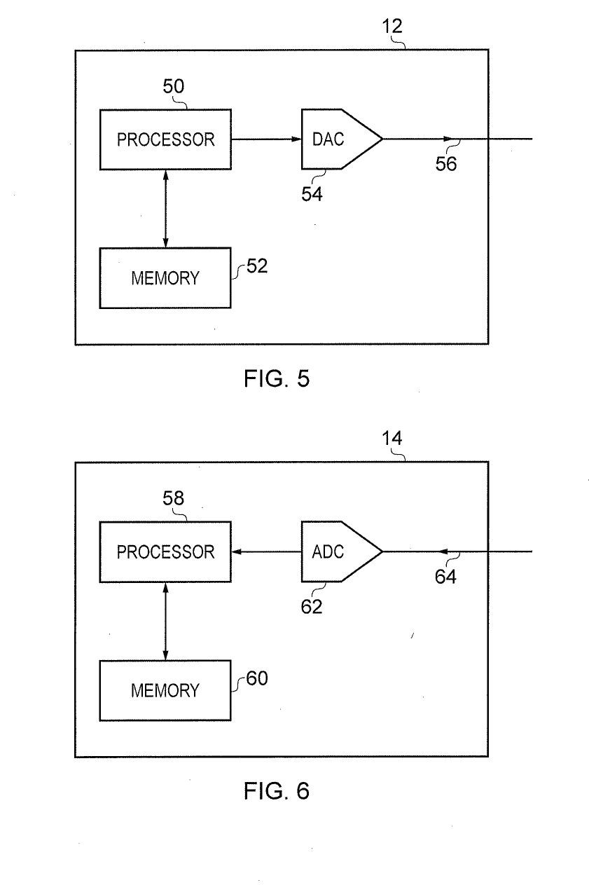

FIG. 5 shows the construction of the transmitter 12 in a little more detail. As shown, the transmitter 12 comprises a processor 50, a memory 52 and a digital to analogue converter (DAC) 54. The processor 50, by drawing on instructions and data stored in the memory 52, produces a digital version of the probe request frame that is to be channelised by the upconverter 16-1 to 16-m. This probe request is then converted to the analogue domain by DAC 54 and the resulting analogue signal 56 is then supplied to the upconverters 16-1 to 16-m.

FIG. 6 shows the construction of the receiver 14 in a little more detail. As shown, the receiver 14 comprises a processor 58, a memory 60 and an analogue to digital converter (ADC) 62. The ADC 62 receives the analogue baseband signal 64 from the down converter 18 and converts it into a digital baseband signal that can be processed by the processor 58. The processor 58 could, for example, be a general purpose processor or a digital signal processor with its functionality set in hardware. The processor 58 performs discrete Fourier transformation on time-sliced blocks of the signal provided by the ADC 62 in order to produce the spectrograms that are used to detect the presence of transmissions received from access points. The processor also undertakes the calculations and algorithms necessary to calculate the various parameters b(f,n) and d_{c}(n). The processor 58 performs these tasks by utilising instructions and data and storage space that is provided by the memory 60.

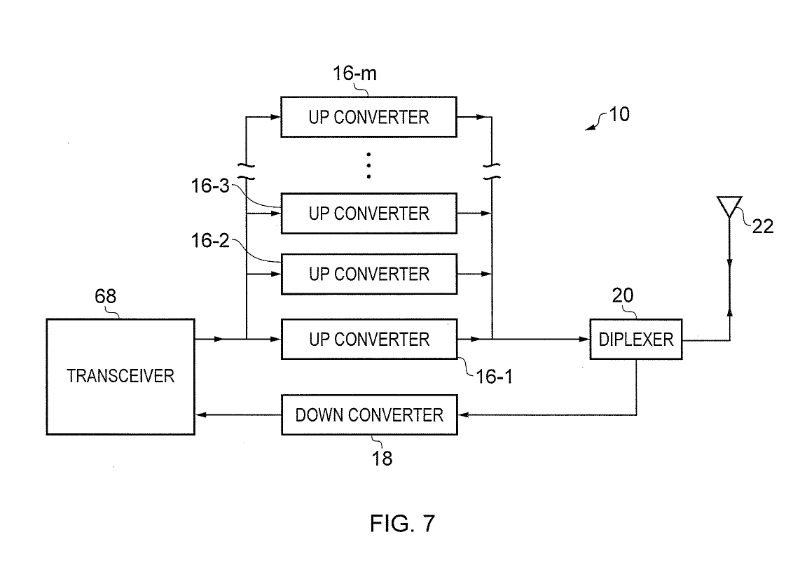

FIG. 7 shows a variant of the station 10 that is shown in FIG. 1. The station 66 is largely the same as station 10 except that the transmitter 12 and the receiver 14 have been replaced by a transceiver 68 which performs the functions of both the transmitter 12 and the receiver 14.

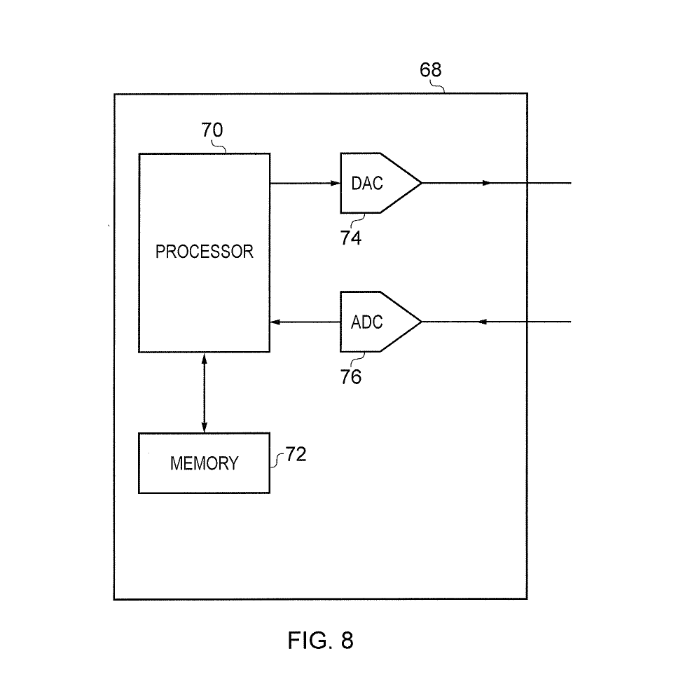

FIG. 8 shows the construction of the transceiver 68 in a little more detail. As shown, the transceiver comprises a processor 70, a memory 72 a DAC 74 and an ADC 76. The processor 70 is arranged to utilise instructions and data that are stored in the memory 72 in order to formulate the probe request frame that is converted by the DAC 74 and supplied to the bank of upconverters 16-1 to 16-m. Likewise, the processor 70 utilises instructions and data in the memory 72 in order to process a version of the signal from the down converter 18 that has been digitised by ADC 76 in order to determine whether the received signal includes transmissions from a wireless access point. That is to say, the processor 70 is arranged to perform the calculations and algorithms necessary to calculate the spectrograms and the parameters b(n,f) and clan) and to make conclusions based on those parameters.

In one variant, the b(f,n) values are modified before being used to calculate the detection criteria d_{c}(n). In this case, b′ values are used in place of the b values and the equation for determining the b′ values is:

$${b}^{′} ( f , n ) = \{ \begin{matrix}1 , & \begin{matrix}\begin{matrix}\underline{if} s ( f , n ) > s ( f , n - K ) \underline{and} \\ s ( f , n ) > max ( \begin{matrix}s ( f - m , n ) , \\ s ( f + m , n )\end{matrix} ) - {A}_{m} ,\end{matrix} \\ for m = 1 , 2 , … M\end{matrix} \\ 0 , & otherwise\end{matrix}$$

Here, the constants Aₘ are chosen in relation to the magnitudes of the discrete Fourier transform of the window that is applied to the blocks of the received signal prior to their discrete Fourier transformation. In other words, b′(f,n) is only 1 if the power in bin f at time n:
exceeds the power in that bin at time n-K and
does not, for each value of m, fall more than an amount Aₘ below the larger of the two neighbouring channels at frequency f−m and f+m.

Where b′ is used, the detection criteria equation is modified to:

$${d}_{c} ( n ) = {\sum }_{f ∈ {F}_{c}} {\sum }_{k = n - L + 1}^{n} {b}^{′} ( f , k )$$

That is to say, b′ is used in place of b.

Various modifications are possible to the embodiments described above, and some of these will now be discussed.

Although the embodiments described above use the Full Band Scan concept together with the multiplexed probe frames concept, this need not be the case and the one could be used without the other. For example, the Full Band Scan could be used to do a passive scan, i.e. a scan that is not driven by any probe request, multiplexed or otherwise. As another example, the receiver 14, instead of being configured to do a Full Band Scan, which is based on spectrum analysis, could be configured to investigate multiple channels simultaneously by performing a clear channel assessment as per the 802.11 standards or having multiple receive chains each tuned to receive a respective one of the channels to be investigated.

1. A station for accessing the resources of an access point in a wireless network, the station comprising a transmitter that is arranged to formulate probe requests and a transmit chain that is arranged to transmit probe requests on multiple channels of the access point simultaneously, wherein the probe requests are configured to elicit responses from the access point.

2. A station according to claim 1, wherein the transmit chain comprises a plurality of upconverters that all operate on a probe request from the transmitter and each upconverter raises the frequency of the probe request to a respective frequency channel of the network.

3. A station according to claim 2, wherein the network has a plurality of channels which together form an operating band and each of the plurality of channels has a respective upconverter in said plurality of upconverters.

4. A station for accessing the resources of an access point in a wireless network, wherein the network comprises a plurality of channels at different frequencies and the station comprises a receiver and a receive chain arranged to deliver to the receiver a signal that has been acquired wirelessly from the network and which spans a plurality of said channels, wherein the receiver is arranged to produce a first spectrogram of the signal and to make a determination, by comparing the first spectrogram with one or more earlier spectrograms of the signal, of whether there is communication starting in the network in a channel covered by the signal.

5. A station according to claim 4, wherein said determination comprises making a comparison, for said channel, of the strength of the part of the signal that falls into that channel in the first spectrogram with the signal the strength of the part of the signal that falls into that channel in one of the one or more earlier spectrograms.

6. A station according to claim 5, wherein said first spectrogram and said one or more earlier spectrograms each extend over a plurality of frequency bins, the channels of spanned by the signal have a frequency width, the frequency bins are each narrower in frequency than said frequency width and the determination further comprises comparing, for a frequency bin, the strength of the part of the signal that that falls into that bin in the first spectrogram with the signal the strength of the part of the signal that falls into that bin in a first one of the one or more earlier spectrograms.

7. A station according to claim 6, wherein said determination further comprises comparing, for a frequency bin, the strength of the part of the signal that that falls into that bin in the first spectrogram with the signal the strength of the part of the signal that falls into that bin in a second one of the one or more earlier spectrograms.

8. A station according to claim 6, wherein said determination further comprises assessing whether, in the first spectrogram, the strength of the part of the signal that falls into said bin falls more than a predetermined amount below the strength of the part of the signal that falls into one or more bins that neighbour said bin.

9. A station according to claim 4, wherein the or each earlier spectrogram precedes the first spectrogram by a respective interval and said determination comprises making, for each frequency bin at each of said one or more earlier spectrograms, a binary decision based on whether or not the strength of the part of the signal falling in the frequency bin in the first spectrogram falls more than a predetermined amount below the strength of the part of the signal falling within the frequency bin in the earlier spectrogram and filtering the binary decisions by frequency bin and by duration of said interval.

10. A station according to claim 9, wherein said determination further comprises making each binary decision also on the basis of whether or not the strength of the part of the signal that falls into the respective bin exceeds the strength of the part of the signal that falls into one or more of said frequency bins neighbouring the respective bin.
